(19) United States
(12) Patent Application Publication
(10) Pub. No.: US 2004/0072119 A1
(43) Pub. Date: Apr. 15, 2004

(54) Self-ligating orthodontic bracket

(75) Inventor: John C. Voudouris, Toronto (CA)

Correspondence Address: MICHAEL BEST & FRIEDRICH, LLP, 100 E WISCONSIN AVENUE, MILWAUKEE, WI, 53202, US

(73) Assignee: OrthoArm, Inc., Toronto (CA)

(21) Appl. No.: 10/601,178

(22) Filed: Jun. 20, 2003

Related U.S. Application Data
(60) Provisional application No. 60/390,745, filed on Jun. 21, 2002.
(60) Provisional application No. 60/400,722, filed on Aug. 2, 2002.

(51) Int. Cl. A61C 3/00

(52) U.S. Cl. 433/11

(57) ABSTRACT

An orthodontic bracket having a body (e.g., made of a ceramic material) including a lingual surface for attachment to a tooth and defining an archwire slot, and a clip movable between an open position permitting access to the archwire slot and a closed position inhibiting access to the archwire slot. In one aspect, the clip has a material thickness that is non-uniform. In another aspect, the clip comprises at least two different materials. In yet another aspect, the bracket includes an insert coupled to the body and at least partially defining the archwire slot, and a recess formed in the archwire slot (e.g., to limit movement of a free end of a labial portion of the clip). In still another aspect, the bracket includes a gingival-occlusal insert coupled to the body and at least partially defining a gingival-occlusal opening, and at least a portion of the clip is positioned in the gingival-occlusal opening. In another aspect, a first side of the insert is longer than a second side in the labial-lingual direction. In yet another aspect, the body includes at least one tie wing having a labial side, a lingual side, and a gingival/occlusal side. The clip includes a labial portion positioned on the labial side of the tie wing, a lingual portion positioned on the lingual side of the tie wing, and a connecting portion positioned on the gingival-occlusal side of the tie wing when the clip is in the closed position. The labial portion has a mesio-distal first width, and the lingual portion has a mesio-distal second width less than the first width. In another aspect of the invention, the body includes a gingival-occlusal opening having a lingual surface, and at least a portion of the insert is spaced from the lingual surface to define at least part of a labial surface of the opening.

### RELATED APPLICATIONS

This application claims priority to U.S. Provisional Application No. 60/390,745 filed Jun. 21, 2002 and to U.S. Provisional Application No. 60/400,722 filed Aug. 2, 2002.

### BACKGROUND OF THE INVENTION

The invention relates to orthodontic brackets and, more particularly, to self-ligating orthodontic brackets.

According to established orthodontic techniques, it is well known to ligate an archwire to an orthodontic bracket utilizing an elastic or metal ligature. In conventional orthodontic brackets, the ligature is wrapped around respective undercuts of gingival and occlusal tie wings so as to overlay the archwire at mesial and distal ends of the orthodontic bracket.

The ligating procedure involves carefully stretching the elastic ligature (or wrapping and twisting a metal ligature) around the tie wings utilizing appropriate orthodontic instruments. The time-consuming ligation procedure results in increased chair time, resulting in higher costs. Furthermore, the elastic ligatures are known to lose their elasticity with time and are subject to degradation. In addition, the elastic and metal ligatures tend to trap food particles in areas of the orthodontic bracket that are difficult for the patient to clean. Also, the elastic and metal ligatures increase the level of friction against the archwire.

To overcome some of the problems associated with conventional orthodontic brackets, designers have created self-ligating brackets that do not require a separate ligature. One type of self-ligating bracket is supplied with a clip that is movable between an open position permitting access to the archwire slot and a closed position inhibiting access to the archwire slot, thereby locking the archwire into the slot. The ligating procedure for self-ligating orthodontic brackets includes positioning the archwire within the archwire slot while the clip is in the open position, and moving the clip into the closed positioned to ligate the archwire to the bracket. Self-ligating brackets substantially decrease the chair time involved in performing the ligation procedure.

### SUMMARY OF THE INVENTION

The present invention relates to several improvements to the prior art orthodontic brackets. Many of these improvements relate to the design of the bracket having a body (e.g., made of a ceramic material) including a lingual surface for attachment to a tooth and defining an archwire slot, and a clip movable between an open position permitting access to the archwire slot and a closed position inhibiting access to the archwire slot. In one aspect, the clip has a material thickness that is non-uniform. For example, the clip can include a labial portion, and the thickness of the clip could reduce along the labial portion from a restrained end (e.g., and occlusal end) to a free end (e.g., a gingival end), preferably by at least 50%.

In another aspect, the clip comprises at least two different materials. For example, one of the clip materials can be laminated to another clip material, one material can be coated onto another material, or one material can be embedded in another material. Preferably, one of the materials is stiffer and/or harder than another material. In one embodiment, at least one of the materials includes a polymer (e.g., polyurethane, fiberglass/resin matrix).

In yet another aspect, the bracket includes an insert coupled to the body and at least partially defining the archwire slot, and a recess formed in the archwire slot. The recess is design to limit movement of the free end of the labial portion of the clip. In one embodiment, the insert includes a recess portion (e.g., in a side of the insert) that defines the recess. In another embodiment, the archwire slot includes a bottom and a side, and the insert extends from the bottom partially up the side leaving an uncovered portion of the archwire slot uncovered by the insert. In this embodiment, the recess is formed in the uncovered portion.

In still another aspect, the bracket includes a gingival-occlusal insert coupled to the body and at least partially defining a gingival-occlusal opening, and a mesio-distal insert coupled to the body and at least partially defining an archwire slot. At least a portion of the clip is positioned in the gingival-occlusal opening. In one embodiment, the gingival-occlusal insert contacts the mesio-distal insert.

In another aspect, the insert is coupled to the body and at least partially defines an archwire slot. The insert includes a bottom, a first side, and a second side, wherein the first side is longer than the second side in the labial-lingual direction. In one embodiment, the insert assists is maintaining a clip in the open position. Preferably, the first side of the insert is the occlusal side.

In yet another aspect of the invention, the body includes at least one tie wing having a labial side, a lingual side, and a gingival/occlusal side. The clip includes a labial portion positioned on the labial side of the tie wing, a lingual portion positioned on the lingual side of the tie wing, and a connecting portion positioned on the gingival-occlusal side of the tie wing when the clip is in the closed position and connecting the labial portion to the lingual portion. The labial portion has a mesio-distal first width, and the lingual portion has a mesio-distal second width less than the first width. For example, the clip can taper from the labial portion to the lingual portion. In one embodiment, the first width is substantially constant along substantially the entire gingival-occlusal length of the labial portion.

In another aspect of the invention, the body includes a gingival-occlusal opening having a lingual surface, and at least a portion of the insert is spaced from the lingual surface to define at least part of a labial surface of the opening. Preferably, at least a portion of a clip is positioned in the opening. Other features and aspects of the invention will become apparent to those skilled in the art upon review of the following detailed description, claims, and drawings, wherein like elements have like numerals throughout the drawings.

### BRIEF DESCRIPTION OF THE DRAWINGS

FIG. 1 is a perspective view of an orthodontic bracket embodying the present invention and having a body and a clip.

FIG. 2 is a front view of the orthodontic bracket of FIG. 1, illustrating an instrument used to move the clip from a closed position to an open position.

FIG. 3 is a cross-section view taken along line 3-3 of FIG. 2, illustrating the clip in a closed position.

FIG. 4 is a cross-section view taken along line 4-4 of FIG. 3, illustrating a gingival-occlusal opening of the orthodontic bracket with the clip removed.

FIG. 5 is a side view of an alternative embodiment of the clip of FIG. 1.

FIG. 6 is a perspective view of an alternative embodiment of the clip of FIG. 1

FIG. 7 is a cross-section view similar to FIG. 3, illustrating a second embodiment of the orthodontic bracket of FIG. 1 with the clip in a closed position.

FIG. 8 is a cross-section view similar to FIG. 7, illustrating the clip in an open position.

FIG. 9 is a cross-section view taken along line 9-9 of FIG. 7, illustrating a gingival-occlusal opening of the orthodontic bracket with the clip removed.

FIG. 10 is a perspective view of an orthodontic bracket according to a third embodiment of the present invention.

FIG. 11 is a perspective view of an orthodontic bracket according to a fourth embodiment of the present invention.

FIG. 12 is front view of the orthodontic bracket of FIG. 11.

FIG. 13 is a partial side view of the orthodontic bracket of FIG. 11.

FIG. 14 is a partial side view of an orthodontic bracket according to a fifth embodiment of the present invention.

FIG. 15 is a perspective view of an orthodontic bracket according to a fifth embodiment of the present invention.

FIG. 16 is a front view of the orthodontic bracket of FIG. 15.

FIG. 17 is a perspective view of an orthodontic bracket according to a sixth embodiment of the present invention.

FIG. 18 is a front view of the orthodontic bracket of FIG. 17.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

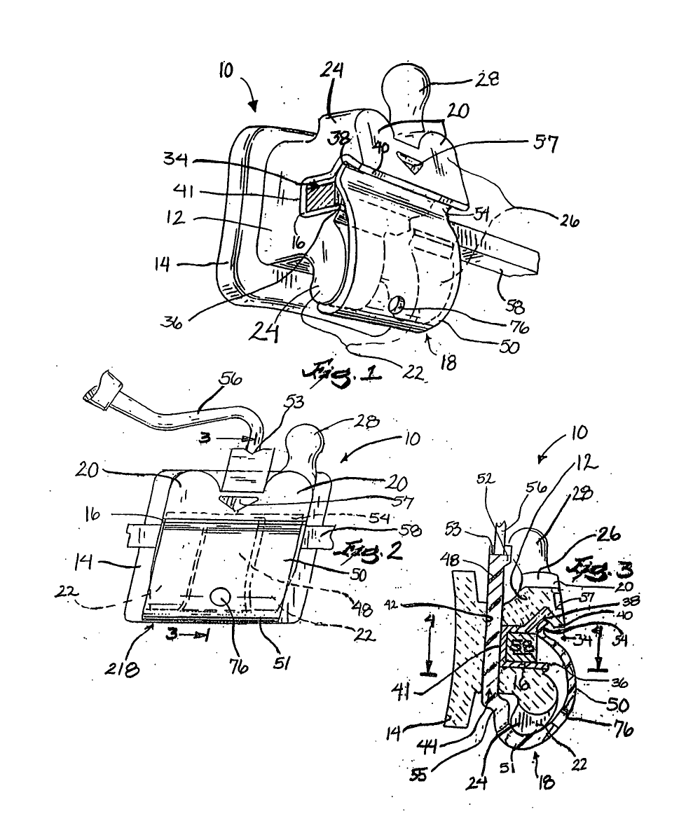

FIG. 1 illustrates a self-ligating orthodontic bracket 10 having a body 12, a mounting pad 14, a lateral insert 16, a clip 18, and a gingival extension 28. The mounting pad 14 includes a lingual surface adapted to be connected to a labial surface of a tooth (not shown). The gingival extension 28 allows the bracket 10 to be connected to other brackets or orthodontic structures via elastomers or other devices.

The body 12 includes a lingual surface that is connected to a labial surface of the mounting pad 14. The body 12 defines gingival and occlusal directions and mesial and distal directions. The body 12 includes two gingival tie wings 20 extending from the body 12 in the gingival direction and two occlusal tie wings 22 extending from the body 12 in the occlusal direction. Although dependent upon the position of the tooth to which the bracket 10 is mounted, the illustrated tie wings 20, 22 can be further identified as mesial tie wings 24 located on the mesial side of the bracket 10 and distal tie wings 26 located on the distal side of the bracket 10.

The body 12 and the mounting pad 14 of the illustrated bracket 10 are made from a ceramic material (e.g., polycrystalline alumina) and are integrally formed with each other. Alternatively, the body 10 and mounting pad 12 can be separate from each other while remaining within the scope of the present invention. The separate body 12 and mounting pad 14 can be connected by an adhesive, resin, weld, or other connecting method known by those of ordinary skill in the art. In addition, the body 12 and the mounting pad 14 could be made from other materials such as polymers, resins, metals, or the like.

As shown in FIGS. 1 and 3, the lateral insert 16 extends laterally in the body 12 to define a labially opening archwire slot 34. The lateral insert 16 includes an occlusal portion that extends labially past the labial surface of the tie wings 20, 22 to define a protrusion 36. The lateral insert 16 also includes a gingival portion that includes a recess 38 having a retaining lip 40. A lingual portion 41 of the lateral insert 16 connects the gingival and occlusal portions. The illustrated lateral insert 16 is made from a metallic material and bonded to the body 12. The lateral insert 16 can be made from a variety of materials including, but not limited to at least one of stainless steel, silver, gold, white gold, niobium, platinum, copper, Ni—Ti, Cr—Co, Teflon-coated metals, marble, granite, or the like. In the case of the illustrated embodiments, the metal lateral insert 16 strengthens the ceramic body 12 and prevents fracture of the body 12 caused by movement of the clip 18 as will be discussed in greater detail below. The lateral insert 16 can also be plasma coated or coated with Teflon or other suitable coating to reduce friction or to match the color of the ceramic body 12.

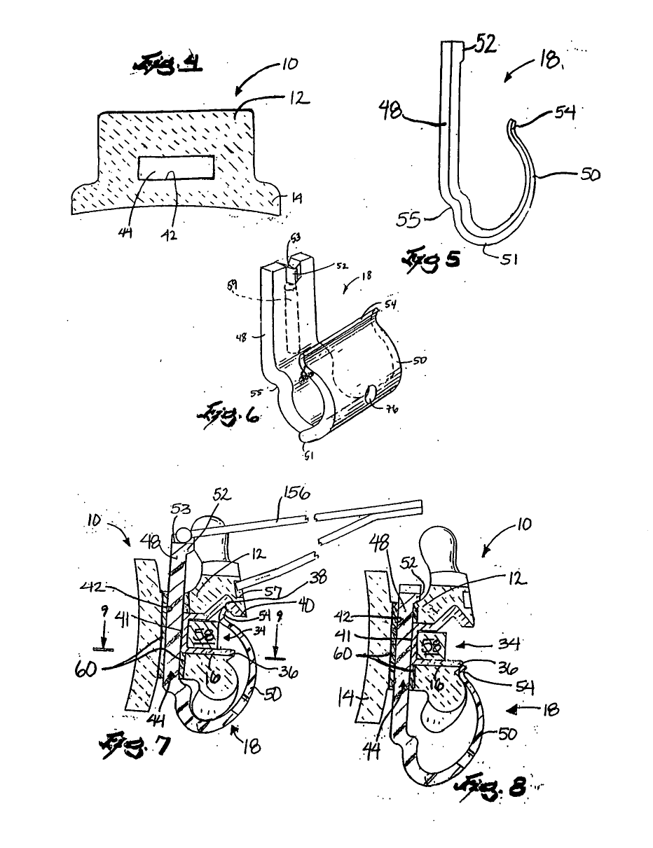

As best shown in FIGS. 3 and 4, a gingival-occlusal opening 44 is defined by a lingual surface 42, a distal surface, a mesial surface, and the lingual portion 41 of the lateral insert 16. The lingual portion 41 of the lateral insert 16 is separated from the lingual surface 42 by a distance to at least partially define the gingival-occlusal opening 44. The gingival-occlusal opening 44 is not necessarily partially formed by the lateral insert 16. That is, the gingival-occlusal opening 44 can be formed through the body 12 without relying on the lateral insert 16 to define a portion of the gingival-occlusal opening 44.

As best shown in FIG. 3, the clip 18 defines a profile that includes a lingual portion 48 and a labial portion 50. The clip 18 includes a flange 52 on the gingival end of the lingual portion 48, and the labial portion 50 includes a restrained occlusal end 51 and a free gingival end 54. The lingual portion 48 is substantially straight, and the labial portion 50 is curved. Specifically, the occlusal end 51 of the labial portion 50 curves in the lingual direction, and the gingival end 54 of the labial portion 50 curves in the labial direction. It should be understood that the labial portion 18 can alternatively have a substantially flatter profile and lie closer to the labial surface of the body 12.

The thickness of the illustrated clip 18 tapers in the labial direction, and the thickness of the labial portion 50 tapers in the gingival direction. More specifically, the labial portion 50 is thinner than the lingual portion 48, and the gingival end 54 of the labial portion 50 is thinner than the occlusal end 51 of the labial portion 50. Even more specifically, the thickness of the labial portion 50 is less than approximately ½ the thickness of the lingual portion 48. It should be understood that the taper of the illustrated clip 18 is not required in all aspects of the present invention.

The lingual portion 48 of the illustrated clip 18 includes a step 55 positioned near the intersection of the labial portion 50 and the lingual portion 48. The step 55 can alternatively be referred to as a dimple, depression, pit, indentation, bump, or the like. It should be appreciated that the step 55 is not required in all aspects of the present invention. The step 55 provides additional flexibility at the point of flexure between the labial portion 50 and the lingual portion 48, thereby reducing the likelihood of fracture. In addition, the step 55 allows for the attachment of elastic or metal ligatures to the body 12 if desired.

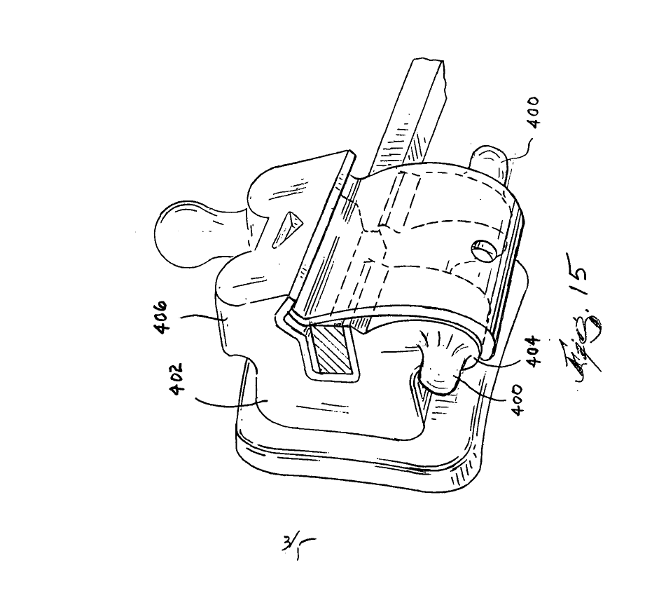

The illustrated clip 18 is made from a clear high density polyurethane, but could be made from other polymers, Plexiglas, plastic, fiberglass, resins, or metals such as stainless steel, silver, gold, white gold, niobium, platinum, copper, Ni—Ti, Cr—Co, or Teflon-coated metals. Alternatively, the clip 18 can comprise at least two of these materials. The different materials can be laminated to each other (see FIG. 5), fused together (see FIG. 13, discussed below), one material can be coated by or embedded within another (see FIG. 6), or the clip 18 can be formed from a combination of these techniques. In FIG. 5, a harder material forms a labial aspect of the lingual portion 48 and a lingual aspect of the labial portion 50 to reduce friction and wear between the clip 18 and the body 12 as the clip 18 is moved between an open and a closed position. In FIG. 6, a harder material (e.g. metal) is positioned in the lingual portion 48 of the clip 18 to form a spine 59 that strengthens and stiffens the lingual portion 48, while leaving the labial portion free from the harder material.

As shown in FIGS. 1 and 3, the clip 18 is positioned on the bracket 10 such that the lingual portion 48 is at least partially positioned within the gingival-occlusal opening 44 and the labial portion 50 curves around the body 12 and biases the gingival end 54 into contact with the labial surface of the body 12. The thickness of the body 12 is greater than the relaxed distance between the labial portion 50 and the lingual portion 48 of the clip 18. When the clip 18 is positioned on the bracket 10, as illustrated in FIG. 3, the labial portion 50 is biased in the lingual direction against the body 12.

The labial portion 50 of the clip 18 is substantially wider than the lingual portion 48, as best illustrated in FIGS. 2 and 6. The labial portion 50 is substantially the same width (mesial to distal) as the lateral insert 16. This width is substantially constant as the labial portion 50 curves around the occusal tie wings 22. Thus, the labial portion 50 covers the occlusal tie wings 22 and provides a smooth contour that is both aesthetically pleasing and comfortable for the wearer. In the illustrated bracket 10, the mesio-distal width of the clip 18 changes abruptly after curving over the occlusal tie wings 22, such that there is a step-down in mesio-distal width between the labial portion 50 and the lingual portion 48.

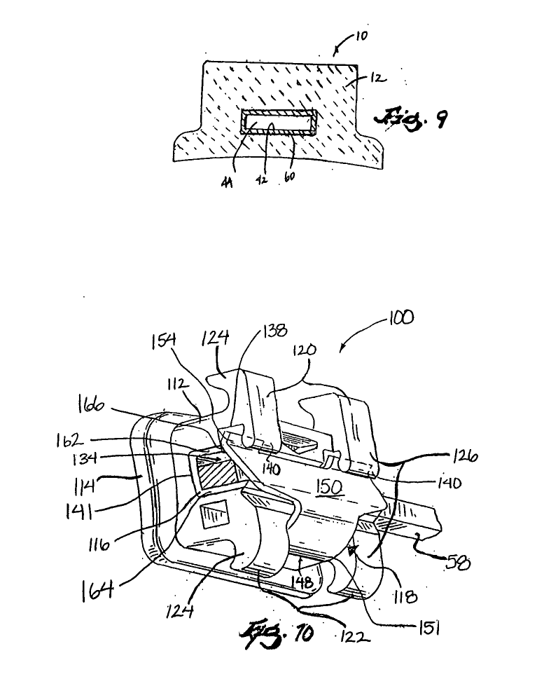

The clip 18 is movable between an open position permitting access to the archwire slot 34 and a closed position inhibiting access to the archwire slot 34. As shown in FIG. 8, the clip 18 has been moved in the occlusal direction (e.g., with a tool 56 as illustrated in FIGS. 2 and 3 or with a tool 156 as illustrated in FIG. 7) until the flange 52 contacts the body 12 and the gingival end 54 of the labial portion 50 is positioned on the occlusal side of the protrusion 36. The movement of the clip 18 in the occlusal direction is stopped by the flange 52, thereby inhibiting the clip 18 from being removed from the gingival-occlusal opening 44. The bias of the clip 18 and the angle of the gingival end 54 acting against the protrusion 36 maintains the clip 18 in the open position.

The tool 56 can be used to move the clip occlusally to an open position by engaging an indentation 53 in the gingival end of the lingual portion 48, as shown in FIGS. 2 and 3. Instead of engaging the indentation 53, the tool 56, or other similar tool, can engage an aperture 76 in the labial portion 50 of the clip 18 to move the clip 18 occlusally to an open position. Alternatively, the tool 156 (see FIG. 7), which functions like a tweezers, can be used to move the clip 18 to an open position. The tool 156 includes two legs, including a first shorter leg designed to be inserted in a triangular depression 57 located on the labial surface of the body 12 between the gingival tie wings 20. The second longer leg of the tool 156 has a spherical tip for facile engagement of the indentation 53. While maintaining the shorter leg of the tool 156 in the triangular depression 57 and the longer leg in the indentation 53, the two legs are squeezed toward one another, thereby moving the clip 18 in the occlusal direction to the open position illustrated in FIG. 8. It should be noted that the triangular depression 57 can be formed of a variety of shapes other than triangular, including square, rectangular, circular, or the like.

As best illustrated in FIGS. 7 and 8, the clip 18 is moved in the occlusal direction to the open position thereby permitting access to the archwire slot 34 and allowing the archwire 58 to be positioned in the archwire slot 34 or removed from the archwire slot 34. The gingival end 54 biases the clip 18 toward the closed position when the gingival end 54 is positioned on the gingival side of the protrusion 36. In the closed position, illustrated in FIGS. 3 and 7, the gingival end 54 actively biases the archwire 58 within the archwire slot 34, thus achieving active ligation of the archwire 58. More specifically, the gingival end 54, when in the first closed position, remains in contact with the archwire 58 and applies a force. The distance between the labial portion 50 and the lingual portion 48 exceeds the relaxed distance, thereby allowing the clip 18 to apply a force and actively ligate the archwire 58. Active ligation continues until the gingival end 54 of the clip 18 engages the recess 38 (specifically, the retaining lip 40), or until the archwire 58 is fully seated into the bottom of the archwire slot 34.

FIGS. 7-9 further illustrate a second embodiment of the bracket 10, wherein the gingival-occlusal opening 44 is defined by a vertical insert 60. In the illustrated embodiment, the vertical insert 60 extends the entire length of the gingival-occlusal opening 44 so that contact between the body 12 and the lingual portion 48 of the clip 18 is reduced. This could be beneficial to prevent wear between the clip 18 and the ceramic body 12. The vertical insert 60 includes a labial portion, a lingual portion, a mesial portion, and a distal portion, as best illustrated in FIG. 9. The labial portion of the vertical insert 60 is at least partially formed by the lingual portion 41 of the lateral insert 16. Therefore, the labial portion of the vertical insert 60 comprises a gingival portion and an occlusal portion separated by the lingual portion 41 of the lateral insert 16, as best illustrated in FIGS. 7 and 8. The vertical insert 60 can be made of a variety of materials, such as stainless steel, silver, gold, white gold, niobium, platinum, copper, Ni—Ti, Cr—Co, Teflon-coated metals, composite bonding material, glass, high density polyurethane, or a combination thereof.

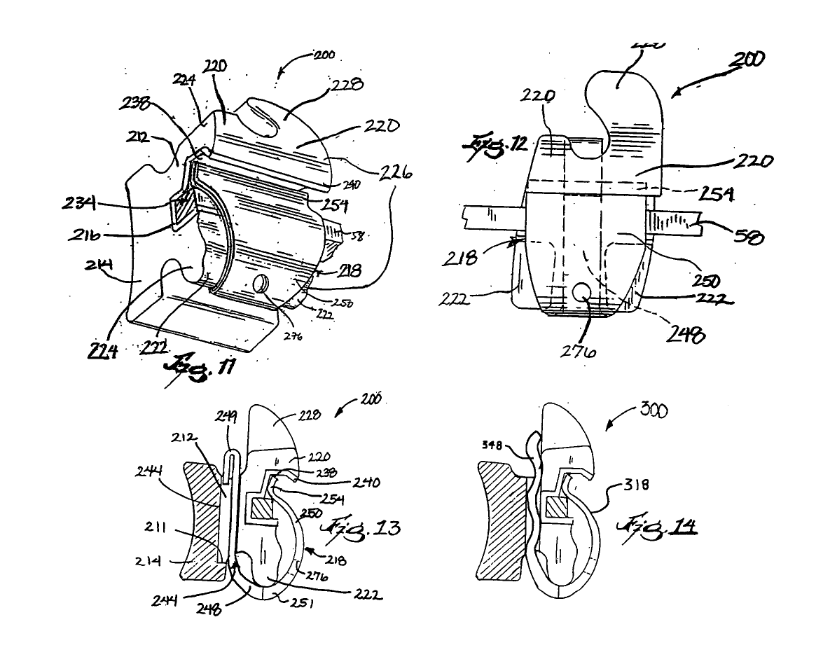

The third embodiment of FIG. 10 includes a body 112, a mounting pad 114, a lateral insert 116 that defines an archwire slot 134, a clip 118, gingival tie wings 120, occlusal tie wings 122, mesial tie wings 124, and distal tie wings 126. The tie wings 120,122 are shaped slightly differently than that of the first and second embodiments. The clip 118 includes a lingual portion 148 and a labial portion 150 having an occlusal end 151 and a gingival end 154. The clip 118 is shorter (gingival to occlusal) than that of the first and second embodiments, since the occlusal end 151 of the clip 118 extends between the occlusal tie wings 122 instead of curving lingually over the occlusal tie wings 122. When the bracket 100 is in the closed position, as shown in FIG. 10, the occlusal end 151 is adjacent an occlusal portion of the body 112 between the occlusal tie wings 122.

The clip 118 of the bracket 100 does not taper in thickness, but it should be understood that the clip 118 can taper in thickness in a manner as described above with respect to the clip 118 of the first and second embodiments. The clip 118 has a first width adjacent the gingival end 154 of the labial portion 150 approximately the same mesio-distal width as the lateral insert 116. The width of the labial portion 150 of the clip 118 then decreases from the gingival end 154 to a second width as the labial portion 150 curves lingually between the tie wings 22. The width of the labial portion 150 of the clip 118 tapers slightly from the first width to the second width. Alternatively, the first width could abruptly change to the second width, or the taper in mesio-distal width could be even more gradual.

The bracket 100 further includes a recess 138 that is generally rectangular and is formed by a retaining lip 140. The recess 138 and the retaining lip 140 are formed in the body 112 without being covered by the lateral insert 116. That is, the archwire slot 134 includes a bottom and a side, and the lateral insert 116 extends from a lingual portion 141 partially up the side, leaving an uncovered portion of the archwire slot 134. The recess 138 is formed in the uncovered portion. The recess 138 can be formed during formation of the body 112 (e.g., during molding or extrusion) or, alternatively, can be formed using a subsequent machining operation. The lateral insert 116 includes a first side portion 162 that is shorter in the labial-lingual direction than a second side portion 164. In the illustrated embodiment, the first side portion 162 corresponds with the gingival side of the archwire slot 134, and the second side portion 164 corresponds with the occlusal side of the archwire slot 134. The first side portion 162 includes a labial end 166 that is flush with a lingual surface of the recess 138.

The fourth embodiment of FIGS. 11-13 includes a bracket 200 having a body 212, a mounting pad 214, a lateral insert 216 that defines an archwire slot 234, a clip 218, gingival tie wings 220, occlusal tie wings 222, mesial tie wings 224, distal tie wings 226, and a gingival extension 228 integrally formed with the mesial gingival tie wing 220, 226. The bracket 200 further includes a recess 238 formed by the retaining lip 240 and having a generally trapezoidal shape.

The clip 218 includes a lingual portion 248 and a labial portion 250 having an aperture 276, an occlusal end 251 and a gingival end 254. As best illustrated in FIG. 12, the clip 218 has a first mesio-distal width adjacent the gingival end 254 that gradually decreases to a second mesio-distal width adjacent the lingual portion 248. That is, the clip 218 includes cut-out portions near the far mesial and distal aspects of the labial portion 250 of the clip 218. The cut-out portions of the clip 218 allow elastomers and other ligatures to be attached to the far mesial and distal aspects of the occlusal tie wings 222. Accordingly, the clip 218 does not require a step for elastomers near the intersection of the labial portion 250 and the lingual portion 248.

FIG. 13 shows a profile of the clip 218. The gingival end of the lingual portion 248 of the clip 218 includes a lingually-curved portion 249. The lingually-curved portion 249 extends a distance occlusally to be parallel with the lingual portion 248 of the clip 218. The lingually-curved portion 249 contacts an occlusal portion 211 of the gingival-occlusal opening 244 when the clip 218 is moved from a closed position to an open position, thereby inhibiting the clip 218 from being removed from the gingival-occlusal opening 244. In addition, the lingually-curved portion 249 of the clip 218 has a natural bias that enables the lingual portion 248 of the clip 218 to frictionally engage the body 212 throughout the length of the gingival-occlusal opening 244 as the clip 218 is moved between an open and a closed position.

The clip 218, as shown in FIG. 13, is formed of two different materials fused together. One material forms the lingual portion 248 of the clip 218, and another material forms the labial portion 250. Particularly, a harder and stronger material (e.g., metal) forms the lingual portion 248, and a material that more closely resembles the color and aesthetics of the body 212 forms the labial portion 250.

The fifth embodiment of FIG. 14 includes a bracket 300 and a clip 318 and is substantially identical to the fourth embodiment with the exception of the configuration of the lingual portion 348 of the clip 318. More specifically, the lingual portion 348 is formed with an undulating shape, which makes the lingual portion 348 act as a wave spring. This design facilitates proper frictional engagement between the clip 318 and the bracket 300. The amount of frictional engagement can be chosen by proper selection of the thickness of the material of the lingual portion 348 and by the shape, amplitude, and frequency of the undulating shape.

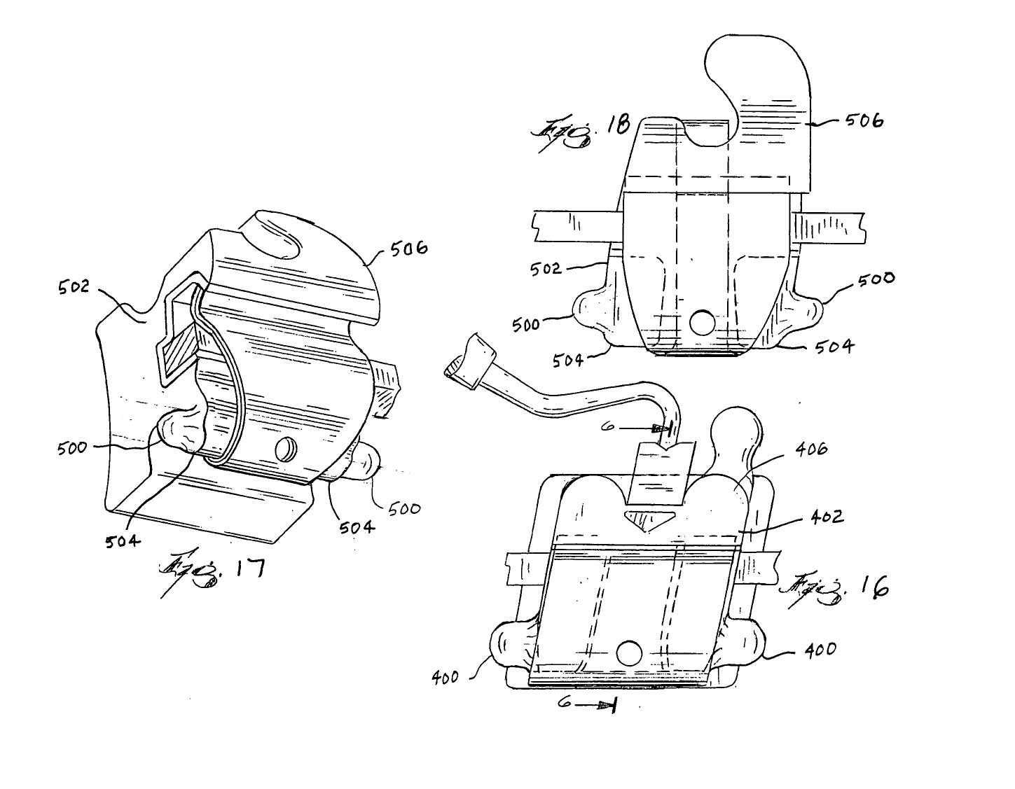

Referring to FIGS. 15-16, the fifth embodiment of the present invention is the same as the first embodiment of FIGS. 1-3 with the addition of lateral wings 400 on the sides of the body 402, and more specifically on the sides of the occlusal tie wings 404. The lateral wings 400 facilitate ligating on the bracket (e.g., using elastomers or wire). If desired, the lateral wings could be added to the gingival tie wings 406 in addition to or instead of the occlusal tie wings 404.

FIGS. 17-18 illustrate a sixth embodiment that is the same as the fourth embodiment of FIGS. 11-13 with the addition of lateral wings 500 on the sides of the body 502, and more specifically on the sides of the occlusal tie wings 504. The lateral wings 500 facilitate ligating on the bracket (e.g., using elastomers or wire). If desired, the lateral wings could be added to the gingival tie wings 506 in addition to or instead of the occlusal tie wings 504.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. An orthodontic bracket comprising:
a body including a lingual surface for attachment to a tooth and defining an archwire slot; and
a clip movable between an open position permitting access to the archwire slot and a closed position inhibiting access to the archwire slot, wherein the clip has a material thickness that is non-uniform.

2. An orthodontic bracket as claimed in claim 1, wherein the clip includes a labial portion with free and restrained ends, and wherein the thickness of the clip reduces from the restrained end to the free end.

3. An orthodontic bracket as claimed in claim 2, wherein the thickness of the free end is less than half the thickness of the restrained end.

4. An orthodontic bracket as claimed in claim 2, wherein the bracket defines lingual and labial directions, and wherein the restrained end of the clip curves in the lingual direction and the free end of the clip curves in the labial direction.

5. An orthodontic bracket as claimed in claim 2, wherein the free end comprises a gingival end.

6. An orthodontic bracket as claimed in claim 1, wherein the clip comprises a polymer.

7. An orthodontic bracket comprising:
a body including a lingual surface for attachment to a tooth and defining an archwire slot; and
a clip comprising at least two different materials and being movable between an open position permitting access to the archwire slot and a closed position inhibiting access to the archwire slot.

8. An orthodontic bracket as claimed in claim 7, wherein the two different materials are laminated to each other.

9. An orthodontic bracket as claimed in claim 7, wherein one material coats the other material.

10. An orthodontic bracket as claimed in claim 7, wherein one material is stiffer than the other material.

11. An orthodontic bracket as claimed in claim 7, wherein one material comprises a polymer material.

12. An orthodontic bracket as claimed in claim 7, wherein the clip comprises a lingual portion and a labial portion, and wherein at least one of said two different materials comprises metal positioned in the lingual portion of the clip.

13. An orthodontic bracket as claimed in claim 7, wherein other material comprises polymer material (e.g., polyurethane, fiberglass/resin matrix).

14. An orthodontic bracket as claimed in claim 7, wherein the clip comprises a lingual portion and a labial portion, and wherein the labial portion of the clip is free from metal.

15. An orthodontic bracket comprising:
a body including a lingual surface for attachment to a tooth and defining a labial-lingual direction; and
an insert coupled to the body and at least partially defining an archwire slot, the insert including a bottom, a first side, and a second side, wherein the first side is longer than the second side in the labial-lingual direction.

16. An orthodontic bracket as claimed in claim 15, further comprising a clip movable between an open position permitting access to the archwire slot and a closed position inhibiting access to the archwire slot, wherein the insert assists is maintaining the clip in the open position.

17. An orthodontic bracket as claimed in claim 15, wherein the insert defines a recess in the archwire slot, wherein a portion of the clip is positioned in the recess when the clip is in the closed position.

18. An orthodontic bracket as claimed in claim 15, wherein the first side comprises a gingival side of the insert.

19. An orthodontic bracket as claimed in claim 15, wherein the body comprises a ceramic material.

20. An orthodontic bracket as claimed in claim 15, wherein the insert comprises a metal material.

21. An orthodontic bracket comprising:
a body including a lingual surface for attachment to a tooth; and
an insert coupled to the body and at least partially defining an archwire slot, the insert including a bottom and two sides;
a recess formed in the archwire slot; and
a clip movable between an open position permitting access to the archwire slot and a closed position inhibiting access to the archwire slot, wherein a portion of the clip is positioned in the recess when the clip is in the closed position.

22. An orthodontic bracket as claimed in claim 21, wherein the insert includes a recess portion that defines the recess.

23. An orthodontic bracket as claimed in claim 21, wherein the clip includes a labial portion having a free end, and wherein the portion of the clip positioned in the recess comprises the free end of the labial portion.

24. An orthodontic bracket as claimed in claim 23, wherein the recess portion of the insert limits movement of the free end of the labial portion.

25. An orthodontic bracket as claimed in claim 21, wherein the recess is formed in a side of the insert.

26. An orthodontic bracket as claimed in claim 25, wherein the sides include a gingival side and an occlusal side, and wherein the recess is formed in the gingival side.

27. An orthodontic bracket as claimed in claim 21, wherein the archwire slot includes a bottom and a side, wherein the insert extends from the bottom partially up the side leaving an uncovered portion of the archwire slot uncovered by the insert, and wherein the recess is formed in the uncovered portion.

28. An orthodontic bracket as claimed in claim 21, wherein the body comprises a ceramic material.

29. An orthodontic bracket as claimed in claim 21, wherein the insert comprises a metal material.

30. An orthodontic bracket comprising:
a body including a lingual surface for attachment to a tooth and a gingival-occlusal opening having a lingual surface;
an insert coupled to the body and at least partially defining an archwire slot, at least a portion of the insert being spaced from the lingual surface and defining at least part of a labial surface of the opening.

31. An orthodontic bracket as claimed in claim 30, further comprising a clip movable between an open position permitting access to the archwire slot and a closed position inhibiting access to the archwire slot, wherein at least a portion of the clip is positioned in the opening.

32. An orthodontic bracket as claimed in claim 30, wherein the body comprises a ceramic material.

33. An orthodontic bracket as claimed in claim 30, wherein the insert comprises a metal material.

34. An orthodontic bracket comprising:
a body including a lingual surface for attachment to a tooth;
a gingival-occlusal insert coupled to the body and at least partially defining a gingival-occlusal opening;
a mesio-distal insert coupled to the body and at least partially defining an archwire slot; and
a clip movable between an open position permitting access to the archwire slot and a closed position inhibiting access to the archwire slot, wherein at least a portion of the clip is positioned in the opening.

35. An orthodontic bracket as claimed in claim 34, wherein the gingival-occlusal insert contacts the mesio-distal insert.

36. An orthodontic bracket as claimed in claim 34, wherein the body comprises a ceramic material.

37. An orthodontic bracket as claimed in claim 34, wherein the gingival-occlusal insert comprises a metal material.

38. An orthodontic bracket as claimed in claim 34, wherein the mesio-distal insert comprises a metal material.

39. An orthodontic bracket comprising:
a body including a lingual surface for attachment to a tooth, the body including an archwire slot and at least one tie wing having a labial side, a lingual side, and a gingival/occlusal side; and
a clip movable between an open position permitting access to the archwire slot and a closed position inhibiting access to the archwire slot, wherein the clip includes:
a labial portion positioned on the labial side of the tie wing, the labial portion having a mesio-distal first width;
a lingual portion positioned on the lingual side of the tie wing, the lingual portion having a mesio-distal second width less than the first width; and
a connecting portion connecting the labial portion to the lingual portion, the connecting portion being position on the gingival-occlusal side of the tie wing when the clip is in the closed position.

40. An orthodontic bracket as claimed in claim 39, wherein the clip tapers from the labial portion to the lingual portion.

41. An orthodontic bracket as claimed in claim 39, wherein the first width is substantially constant along the gingival-occlusal length of the labial portion.

42. An orthodontic bracket as claimed in claim 39, wherein the body includes a gingival-occlusal opening and wherein at least a portion of the lingual portion is position in the opening.

43. An orthodontic bracket as claimed in claim 39, wherein the gingival-occlusal side comprises the gingival side of the tie wing.

44. An orthodontic bracket comprising:
a body including a lingual surface for attachment to a tooth, the body including an archwire slot defining a mesio-distal axis;
a clip movable between an open position permitting access to the archwire slot and a closed position inhibiting access to the archwire slot; and
a lateral wing extending from the body in a direction substantially parallel to the mesio-distal axis.

45. An orthodontic bracket as claimed in claim 44, wherein the body includes a tie wing and wherein the lateral wing extends from the tie wing.

46. An orthodontic bracket as claimed in claim 45, wherein the tie wing comprises an occlusal tie wing.

47. An orthodontic bracket as claimed in claim 44, wherein the mesio-distal axis defines a mesial direction and a distal direction, wherein the lateral wing extends in the mesial direction, and wherein the bracket includes another lateral wing extending in the distal direction.

48. An orthodontic bracket as claimed in claim 15, wherein the insert comprises a granite material.

49. An orthodontic bracket as claimed in claim 15, wherein the insert comprises a marble material.

50. An orthodontic bracket as claimed in claim 21, wherein the insert comprises a granite material.

51. An orthodontic bracket as claimed in claim 21, wherein the insert comprises a marble material.

52. An orthodontic bracket as claimed in claim 30, wherein the insert comprises a granite material.

53. An orthodontic bracket as claimed in claim 30, wherein the insert comprises a marble material.

54. An orthodontic bracket as claimed in claim 34, wherein the mesio-distal insert comprises a granite material.

55. An orthodontic bracket as claimed in claim 34, wherein the mesio-distal insert comprises a marble material.
